(19) United States
(12) Patent Application Publication
(10) Pub. No.: US 2006/0061993 A1
(43) Pub. Date: Mar. 23, 2006

(54) Dual-purpose clamping socket

(76) Inventor: Eagle Fan, Chu Pei City (TW)

Correspondence Address: SUPREME PATENT SERVICES, P.O. BOX 2339, SARATOGA, CA, 95070-0339, US

(21) Appl. No.: 10/950,308

(22) Filed: Sep. 23, 2004

(51) Int. Cl. F21V 33/00

(52) U.S. Cl. 362/253

(57) ABSTRACT

A dual-purpose clamping socket contains a main body provided with two clamping pieces at its top end for clamping to fix an electronic product, such as a mobile phone or a PDA. The front end of the main body is a semi-oval having a vibration motor arranged therein, and the front end further combined with an arcuate massage mantle for covering components inside. A battery pack and a switch are also disposed in the main body for driving and controlling the vibration motor. Therefore, the clamping socket of the present invention is a dual-purpose device for clamping an electronic product, particularly in car, or for massaging.

### BACKGROUND OF THE INVENTION

1. Field of the Invention

The present invention relates to a clamping socket for clamping an electronic product, and more specifically, to a dual-purpose clamping structure that can serve for a clamping socket and a massager concurrently.

2. The Prior Arts

Thanks to the booming wireless communication technology, many powerful handheld electronic products are now available in the market, such as mobile phones and personal digital assistants (PDAs). Taking PDA as an example, in addition to recording of events, some of the most powerful PDA also features satellite positioning by GPS. Such devices are often fixed inside a car for guiding drivers and a device for fixing them is needed inside the car.

As most white-collars are in lack of sports, massage is usually deemed a good way to alleviate and relieve people's tensioned nerves and backbones. However, in view of the high-price bulky massage chair, a delicate and simple massage structure of the present invention is therefore provided to a clamping socket used for clamping an electronic product.

### SUMMARY OF THE INVENTION

The primary object of the present invention is to provide a clamping socket that can also serve for a massager, such that the present invention is a clamping socket for clamping a mobile phone or a PDA in car, or a massager whenever desired.

Another object of the present invention is to provide a clamping socket that can also serve for a flashlight because of an illumination device disposed at the tail end of a main body of the clamping socket.

For more detailed information regarding advantages or features of the present invention, at least one example of preferred embodiment will be described below with reference to the annexed drawings.

### BRIEF DESCRIPTION OF THE DRAWINGS

The related drawings in connection with the detailed description of the present invention to be made later are described briefly as follows, in which:

FIG. 1 is a perspective view of a clamping socket of the present invention;

FIG. 2 is a perspective view showing opening state of clamping pieces of the present invention;

FIG. 3 is a perspective view showing a front end of a main body of the clamping socket of the present invention;

FIG. 4 is a perspective view of the clamping socket of the present invention taken at different perspective; and

FIG. 5 is a perspective view of the clamping socket, partially broken, taken at a further perspective.

### DETAILED DESCRIPTION OF THE PREFERRED EMBODIMENT

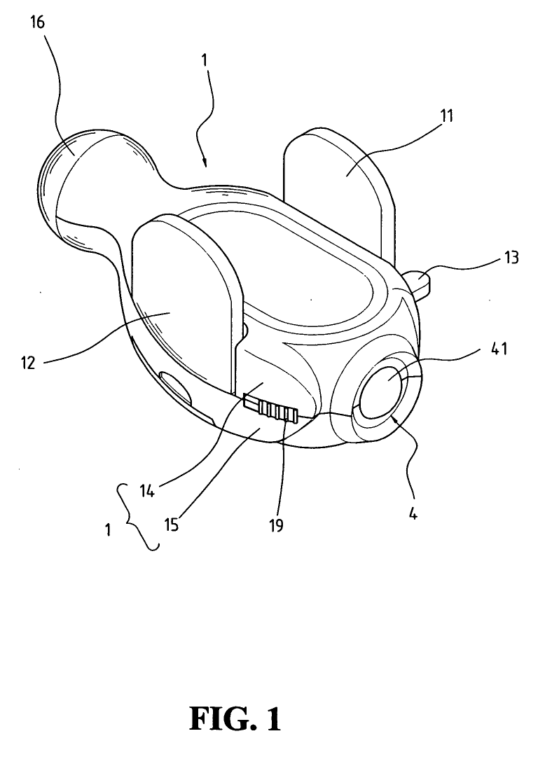

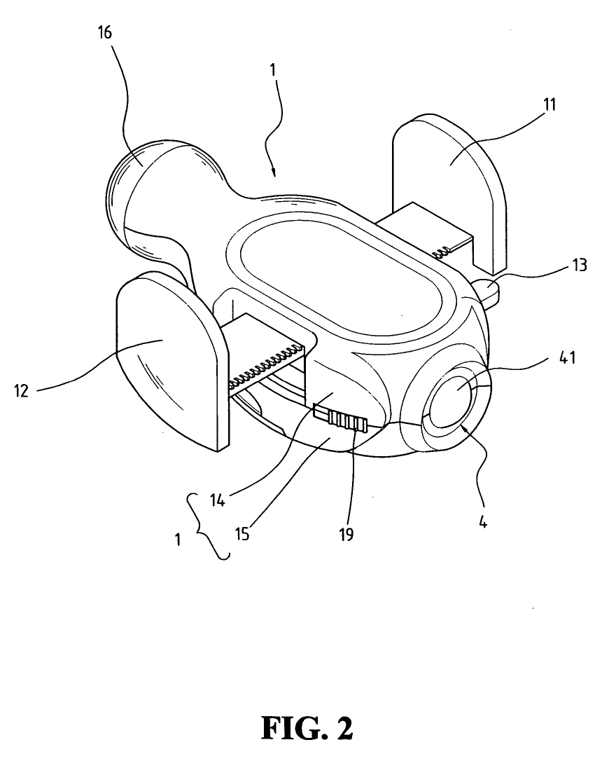

With reference to the drawings and in particular to FIGS. 1 and 2, a clamping socket constructed in accordance with the present invention comprises a main body 1 provided with two clamping pieces 11, 12 at its head, where the clamping pieces 11, 12 are movable synchronously (as shown in FIG. 2) to clamp a mobile phone or PDA of different sizes. There is also an interactive mechanism arranged in the main body 1, in which a tactile switch 13 is touched to open the clamping pieces, which are pinched to clamp something inside as known already. Such a clamping structure may be alternatively composed of a movable- and a stationery-clamping piece.

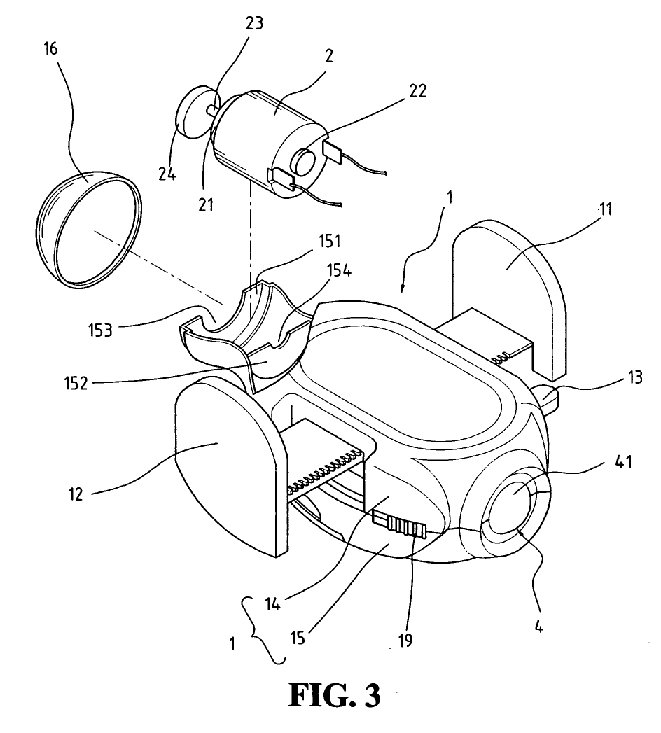

A specific structure is provided to the front end of the main body 1 to make the present invention a massager possible according to FIG. 3. The main body 1 is formed by oppositely locking an upper and a lower cover 14, 15 together, and the inside space is reserved for accommodating and covering relevant components. The front end of the main body 1 is a semi-oval with an inside vibration motor 2, in which a fixing piece 151, 152 formed with a semi-circular recess 153, 154 in different sizes is arranged at the front and the rear respectively inside the lower cover 15. When assembling, the recesses are cogged at the front and the rear end 21, 22 of the vibration motor, respectively, and corresponding fixing pieces are also formed inside the upper cover 14 (not shown), so that the vibration motor 2 is fixed in the main body 1 when the covers 14, 15 are locked together. Besides, a semi-spherical massage mantle 16 is disposed at the front-most end of the main body 1 for covering the vibration motor 2 and relevant components on the one hand and for achieving massage efficacy on the other hand by touching the smooth surface of the mantle 16 to people's body by means of vibration of the motor 2. The massage mantle 16 could be made of a plastic material, the same with that of the main body 1, or soft rubber for enhancing the comfortableness of massage.

The vibration motor 2 is basically an electrical motor combined with a counterweight 24 arranged at the front end of an eccentric shaft 23 of the motor to thereby obtain the vibration effect, or the counterweight may be disposed centrally with a non-uniform weight distribution.

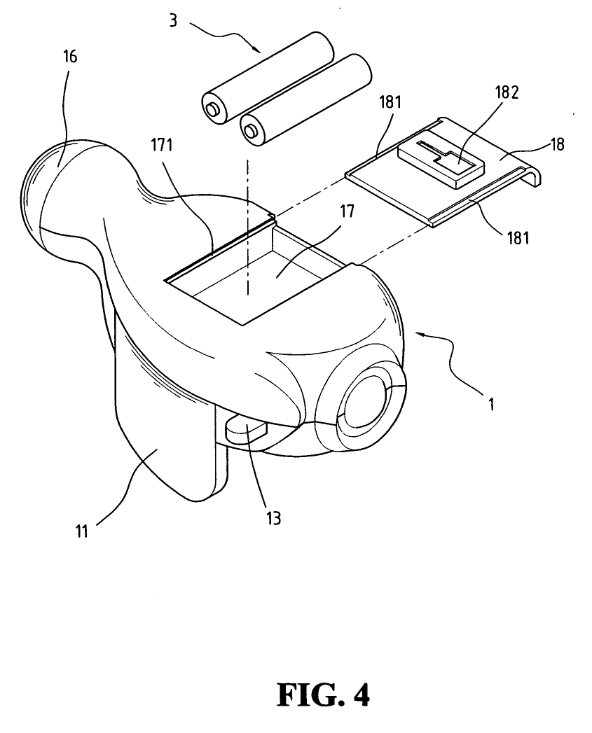

Referring to FIG. 4, a battery pack 3 composed of a plurality of batteries is arranged on the back of the main body 1, where a battery chamber 17 and a battery cover 18 are provided to the back of the main body 1 for facilitating replacement of batteries. A guide groove 171 is formed on each of two sides of the battery chamber 17, while a slide strip 181 to be inserted in the guide grooves 171 is arranged on the battery cover 18. Moreover, a specifically configured recess 182 formed on the battery cover 18 is provided to make it easier for fixing a component in a car through the clamping socket. A switch 19 (shown in FIG. 3) is arranged laterally on the main body 1, in which electric cords are wired to connect with the battery pack 3 and the vibration motor 2 for control ON/OFF operation of power supply.

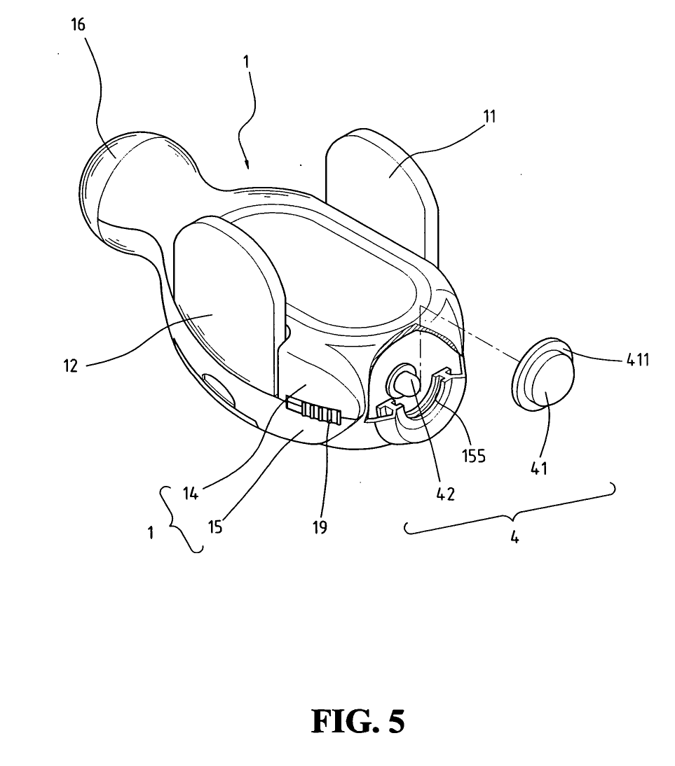

As indicated in FIG. 5, an illumination device 4 is further disposed at the tail end of the main body 1, which comprises a transparent converging lens 41 and an LED 42 inside the main body, in which the power required is supplied by the battery pack 3 and controlled by the switch 19. The lens 41 is fixed by forming a circular choking groove 155 at the tail end of the lower cover 15, having a suitable width for seizing the verge 411 of the lens 41, and the upper cover 14 is correspondingly structured inside so that the lens 41 can be fixed when the covers 14, 15 are combined together face-to-face.

Summarizing the above, the present invention has a vibration motor arranged in a clamping socket to enable the socket become a massager in addition to a clamper. The clamping socket could also serve for a flashlight because of an illumination device arranged at the tail end of the main body thereof.

In the above described, at least one preferred embodiment has been described in detail with reference to the drawings annexed, and it is apparent that numerous changes or modifications may be made without departing from the true spirit and scope thereof, as set forth in the claims below.

What is claimed is:

1. A clamping socket, comprising:
a main body of clamping socket having two clamping pieces, in which at least one clamping piece is movable;
a vibration motor disposed at one end in the main body, in which a semi-spherical massage mantle for covering components is arranged at the front end of the main body, and a rotation shaft of the motor is eccentrically coupled with a counterweight;
a battery pack arranged in the main body for providing electric power to the vibration motor; and
a switch positioned laterally on the main body for controlling ON/OFF operation of the vibration motor.

2. The clamping socket as claimed in claim 1, wherein an illumination device is further disposed at the tail end of the main body.

3. The clamping socket as claimed in claim 2, wherein the illumination device further comprises a lens arranged at the tail end of the main body and an inside LED.

4. The clamping socket as claimed in claim 1, wherein a front end of the rotation shaft of the vibration motor is coupled with a counterweight having a heavier corner.

5. The clamping socket as claimed in claim 1, wherein the main body is formed by locking an upper and a lower cover face-to-face; the front end thereof is a semi-oval; a fixing piece formed with a semi-circular recess in different sizes is arranged at the front and the rear respectively inside the covers and cogged at the front end and the rear end of the vibration motor.

6. The clamping socket as claimed in claim 1, wherein the battery pack is resided on the back of the main body and composed of several batteries; and a battery chamber and a battery cover are arranged on the back of the main body for accommodating the battery pack.
